(19) United States
(12) Patent Application Publication
(10) Pub. No.: US 2008/0107813 A1
(43) Pub. Date: May 8, 2008

(54) Composition and method for coating thermoplastic resin beads for imitation pearls

(76) Inventor: Young Nam Rhee, Seoul (KR)

Correspondence Address: PARK LAW FIRM, 3255 WILSHIRE BLVD, SUITE 1110, LOS ANGELES, CA, 90010, US

(21) Appl. No.: 11/592,645

(22) Filed: Nov. 3, 2006

(51) Int. Cl. C09D 101/02; B05D 3/10

(52) U.S. Cl. 427/322; 106/203.3

(57) ABSTRACT

Disclosed herein are a composition and a method for coating thermoplastic resin beads for imitation pearls used in a variety of accessories.

The coating composition comprises pyroxylin, ethyl acetate, amyl acetate, camphor, and a pigment in an optimal ratio. The coating method comprises the steps of surface-treating resin beads with a surface-treating agent and coating the surface-treated resin beads with the coating composition. The surface-treated resin beads sequentially undergo first coating, second coating, and third coating. The surface-treated resin beads are repeatedly coated with one or two compositions selected from a primer coating composition, an intermediate coating composition, and a top coating composition.

### BACKGROUND OF THE INVENTION

1. Field of the Invention

The present invention relates to a composition and a method for coating thermoplastic resin beads for imitation pearls used in a variety of ornaments, including accessories (e.g., necklaces, bracelets and rings).

2. Description of the Related Art

Conventional imitation pearls are produced by dissolving nitrocellulose in a solvent, such as acetone, butyl acetate or a mixture thereof, adding bismuth oxychloride (BiOCl) as a pigment non-toxic to humans, instead of a general pigment, to the nitrocellulose solution, and coating the mixture on thermoplastic resin beads.

Many problems have, however, been encountered in the use of nitrocellulose. For example, the solubility and dispersibility of titanium dioxide and bismuth oxychloride in nitrocellulose are poor. Also, since nitrocellulose is highly sensitive to ultraviolet (UV) rays, imitation pearls produced using nitrocellulose tend to yellow. Further, when nitrocellulose is mixed with titanium dioxide and a particular pigment to impart desired luster and intended physical properties to imitation pearls, the production procedure of the imitation pearls becomes complicated and it is difficult to optimize the constituent components and contents thereof. As a result, the imitation pearls lack a soft and bright texture unlike that of natural pearls, causing poor marketability of the imitation pearls.

On the other hand, non-coated thermoplastic resins, such as acrylic, ABS and high-impact resins, have been used as main materials for beads. Although these resins are surface-polished before coating, they are still highly sensitive to chemicals, thus losing their commercial value.

Korean Patent No. 586152, entitled “Method for coating thermoplastic resin beads for imitation pearls”, issued to the present applicant, and U.S. Patent Application Serial No. 2004-825197, entitled “Method for coating thermoplastic resin beads for use in imitation pearls”, which was filed by the present applicant (hereinafter, both of which are referred to as “the prior art”), disclose compositions and methods for coating resin beads containing substantially no lead component.

According to the prior art, however, since a large amount of pyroxylin is blended and other additives are not blended in an optimum ratio, the coating compositions have the problems of high viscosity, long coating time, thick surface coating, long drying time, and high production costs.

### SUMMARY OF THE INVENTION

Therefore, the present invention has been made in view of the problems of the prior art, and it is an object of the present invention to provide a composition and a method for coating resin beads for imitation pearls wherein the resin beads are surface-treated with a chemical, followed by coating, such that better effects are provided in terms of color and luster, a cost reduction is achieved, and coating time and drying time are shortened, thus contributing to an improvement in productivity and efficiency.

In accordance with one aspect of the present invention, there is provided a composition for coating resin beads for imitation pearls which comprises pyroxylin, ethyl acetate, amyl acetate, camphor, and a pigment.

In accordance with another aspect of the present invention, there is provided a method for coating resin beads for imitation pearls, the method comprising the steps of:

(a) surface-treating resin beads with a surface-treating agent; and

(b) coating the surface-treated resin beads twice or more with the coating composition.

### DESCRIPTION OF THE PREFERRED EMBODIMENTS

The present invention provides a composition for coating resin beads for imitation pearls which comprises pyroxylin, ethyl acetate, amyl acetate, camphor, and a pigment.

Specifically, the coating composition of the present invention may be a primer coating composition, an intermediate coating composition, or a top coating composition.

The primer coating composition comprises 1.5 to 6% by weight of pyroxylin, 25 to 60% by weight of ethyl acetate, 30 to 70% by weight of amyl acetate, 0.1 to 0.7% by weight of camphor, and 1 to 8% by weight of a pigment.

The intermediate coating composition comprises 1.5 to 6% of pyroxylin, 22 to 45% by weight of ethyl acetate, 30 to 70% by weight of amyl acetate, 0.1 to 0.7% by weight of camphor, and 1 to 8% by weight of a pigment.

The top coating composition comprises 1.5 to 6% by weight of pyroxylin, 10 to 40% by weight of ethyl acetate, 35 to 80% by weight of amyl acetate, 0.1 to 0.7% by weight of camphor, and 1 to 8% by weight of a pigment.

The reason for the use of amyl acetate in the coating composition of the present invention is that amyl acetate is insoluble in the thermoplastic resin beads and is stable without causing any trouble on the surface of the resin beads.

The amount of amyl acetate used in the intermediate coating composition must be at least 3% higher than that used in the primer coating composition. The amount of amyl acetate in the top coating composition must be at least 3% higher than that used in the intermediate coating composition. This increase in the content of amyl acetate in the respective coating compositions is effective in improving the lubricity and luster of the surface of final imitation pearls.

Since bismuth oxychloride used in the coating composition of the present invention is highly priced, a portion of the bismuth oxychloride may be replaced with titanium dioxide in terms of cost reduction. When a mixture of titanium dioxide and bismuth oxychloride is used, the weight ratio of the titanium dioxide to the bismuth oxychloride is 60-90:10-40.

First, pyroxylin is placed in a vessel, and is then dissolved in an appropriate solvent. As the solvent, there may be used, for example, acetone, ethyl acetate, a mixture of acetone and ethyl acetate, a mixture of ethyl acetate and butyl acetate, or a mixture of acetone and butyl acetate. The pyroxylin solution is used as a preliminary solution, which is effective in raising the production efficiency of the final imitation pearls.

The present invention also provides a method for coating resin beads for imitation pearls, comprising the steps of (a) surface-treating resin beads with a surface-treating agent, and (b) coating the surface-treated resin beads twice or more with the coating composition.

The surface-treating agent comprises 1.5 to 6% by weight of pyroxylin, 20 to 50% by weight of acetone, 20 to 50% by weight of ethyl acetate, 10 to 30% by weight of butyl acetate, 0.1 to 0.7% by weight of camphor, and 2 to 10% by weight of a benzene compound.

The surface-treated resin beads may sequentially undergo first coating, second coating, and third coating.

The surface-treated resin beads may be repeatedly coated with one composition selected from a primer coating composition, an intermediate coating composition, and a top coating composition.

The surface-treated resin beads may be coated twice or more with two compositions selected from a primer coating composition, an intermediate coating composition, and a top coating composition.

The coating composition of the present invention is exclusively used to coat thermoplastic resin beads for imitation pearls. The coating composition of the present invention can be used to coat beads other than thermoplastic resin beads. At this time, the coating composition of the present invention may be coated on beads other than thermoplastic resin beads without performing the surface treatment.

The coating method of the present invention enables mass production of highly soft and lustrous imitation pearls.

Since a small amount of pyroxylin is used in the coating method of the present invention as compared to in conventional coating methods, the coating composition is relatively diluted, and the coating time and drying time are shortened. Accordingly, the coating method of the present invention can solve the shortcomings of conventional coating methods.

Camphor is used as a plasticizer in the coating method of the present invention. The camphor functions to control the stickiness of the coating composition and to provide uniform coating effects, thus achieving good appearance of the final products.

In addition, since the amounts of pyroxylin and bismuth oxychloride used in the coating method of the present invention are decreased, the production costs are reduced by about 20% and the production efficiency is doubled.

The coating method of the present invention will be specifically explained below.

First, thermoplastic resin beads for imitation pearls are surface-treated with a solution containing pyroxylin, acetone, ethyl acetate, butyl acetate, camphor and benzene.

Subsequently, a solution containing pyroxylin, ethyl acetate, amyl acetate, camphor and a pigment is coated on the surface-treated thermoplastic resin beads.

Three blends (i.e. primer coating, intermediate coating and top coating compositions) can be obtained from the solution containing pyroxylin, ethyl acetate, amyl acetate, camphor and a pigment.

Depending on coating methods of thermoplastic resin beads for imitation pearls, one or more compositions selected from the following coating compositions may be used.

First, thermoplastic resin beads are surface-treated with a surface-treating agent comprising 1.5 to 6% by weight of pyroxylin, 20 to 50% by weight of acetone, 20 to 50% by weight of ethyl acetate, 10 to 30% by weight of butyl acetate, 0.1 to 0.7% by weight of camphor, and 2 to 10% by weight of benzene. At this time, an aromatic compound (e.g., toluene) may be used instead of the benzene. Thereafter, the surface-treated thermoplastic resin beads are coated with a primer coating composition, an intermediate coating composition or a top coating composition to obtain the final products.

The primer coating composition comprises 1.5 to 6% by weight of pyroxylin, 25 to 60% by weight of ethyl acetate, 30 to 70% by weight of amyl acetate, 0.1 to 0.7% by weight of camphor, and 1 to 8% by weight of a pigment.

The intermediate coating composition comprises 1.5 to 6% of pyroxylin, 20 to 45% by weight of ethyl acetate, 30 to 70% by weight of amyl acetate, 0.1 to 0.7% by weight of camphor, and 1 to 8% by weight of a pigment.

The top coating composition comprises 1.5 to 6% by weight of pyroxylin, 20 to 45% by weight of ethyl acetate, 35 to 80% by weight of amyl acetate, 0.1 to 0.7% by weight of camphor, and 1 to 8% by weight of a pigment.

In the coating method of the present invention, pyroxylin is used instead of nitrocellulose, which is used in conventional coating methods; camphor is used as a plasticizer; and acetone, butyl acetate, ethyl acetate or a mixture thereof is used as a solvent to dissolve the pyroxylin and the plasticizer. As another solvent, amyl acetate, which is an esterification product of acetic acid and amyl alcohol and is lubricative, is used. By mixing the components of the composition in a specified ratio, optimum conditions close to natural pearls are created.

The amount of pyroxylin used in the coating method of the present invention is much smaller than in conventional coating methods. In addition, the coating composition is relatively diluted, and the coating time and the drying time are shortened, thus ensuring maximal production of the final products. Accordingly, the coating method of the present invention solves the shortcomings of conventional coating methods.

Furthermore, since the amounts of pyroxylin and bismuth oxychloride used in the coating method of the present invention are decreased, the production costs are reduced by about 20% when compared to conventional coating methods.

As the pigment used in the present invention, there can be used a mixture of 10 to 40% by weight of a pigment whose major component is bismuth oxychloride, which is the most suitable for the creation of pearl luster, and 60 to 90% by weight of a titanium dioxide powder.

In the coating method of the present invention, ethyl acetate used as a solubilizer of the primer coating, intermediate coating and top coating compositions can be replaced by acetone. At this time, it is preferred to use the acetone in the same amount (% by weight) as the ethyl acetate.

Hereinafter, the constitutions of the present invention will be explained in more detail with reference to the following examples.

### EAMPLES

### Example 1

After 0.8 kg of pyroxylin was put into a 20 liter vessel, 7 kg of acetone, 1.2 kg of benzene, 7.5 kg of ethyl acetate, 3.5 kg of butyl acetate and 0.1 kg of camphor were added thereto. The mixture was homogeneously stirred to obtain a coating composition for surface treatment. Thermoplastic resin beads were dipped in the coating composition to perform surface treatment of the resin beads.

Separately, 0.8 kg of pyroxylin and 0.07-0.08 kg of camphor were introduced into a 20 liter vessel, and then 10 kg of ethyl acetate was added thereto. To the mixture were sequentially added 10 kg of amyl acetate with stirring and 1-1.5 kg of a liquid pearl pigment whose main component is bismuth oxychloride. The resulting mixture was stirred to completely dissolve the pigment particles, yielding a primer coating composition as a viscous liquid.

Next, the surface-treated thermoplastic resin beads were dipped in the primer coating composition to coat the thermoplastic resin beads with the primer coating composition, and then the coated thermoplastic resin beads were dried at 45° C. for 20-30 minutes.

On the other hand, 0.8 kg of pyroxylin and 0.08-0.09 kg of camphor were introduced into a 20 liter vessel, and then 8 kg of ethyl acetate was added thereto. To the mixture were sequentially added 12 kg of amyl acetate with stirring and 1-1.5 kg of a liquid pearl pigment whose main component is bismuth oxychloride. The resulting mixture was stirred to completely dissolve the pigment particles, yielding an intermediate coating composition as a viscous liquid.

Next, the thermoplastic resin beads coated with the primer coating composition were dipped in the intermediate coating composition to coat the thermoplastic resin beads with the intermediate coating composition, and then the coated thermoplastic resin beads were dried at 45° C. for 20-30 minutes to produce imitation pearls.

The imitation pearls thus produced contained lead in an amount of 0.0025% (25 ppm) or less, and exhibited the same soft, glittering, splendid and mysterious color and luster as those of natural pearls.

### Example 2

Imitation pearls were produced in the same manner as in Example 1, except that the following coating compositions were used: a coating composition for surface treatment comprising 0.8 kg of pyroxylin, 4.8 kg of acetone, 0.96 kg of benzene, 12.6 kg of ethyl acetate, 6.08 kg of butyl acetate and 0.07-0.12 kg of camphor; a primer coating composition comprising 0.9 kg of pyroxylin, 0.07-0.09 kg of camphor, 10.5 kg of ethyl acetate, 10.2 kg of amyl acetate and 3 kg of a pigment whose main component is bismuth oxychloride; and an intermediate coating composition comprising 0.9 kg of pyroxylin, 0.09-0.12 kg of camphor, 7.5 kg of ethyl acetate, 12 kg of amyl acetate and 1.5 kg of a pigment whose main component is bismuth oxychloride.

In this example, thermoplastic resin beads for imitation pearls were subjected to primer coating and intermediate coating only without performing top coating.

### Example 3

Imitation pearls were produced in the same manner as in Example 1, except that thermoplastic resin beads for imitation pearls were coated three times with a top coating composition only without performing primer coating and intermediate coating.

The top coating composition was composed of 0.8 kg of pyroxylin, 0.08-0.1 kg of camphor, 8 kg of ethyl acetate, 15.68 kg of amyl acetate and 0.32 kg of a pigment whose main component is bismuth oxychloride.

### Example 4

Imitation pearls were produced in the same manner as in Example 1, except that thermoplastic resin beads for imitation pearls were coated with a primer coating composition and a top coating composition only without performing intermediate coating.

The primer coating composition was composed of 0.9 kg of pyroxylin, 0.07-0.08 kg of camphor, 10.5 kg of ethyl acetate, 10.2 kg of amyl acetate and 3 kg of a pigment (2 kg of titanium dioxide and 1 kg of bismuth oxychloride).

The top coating composition was composed of 0.9 kg of pyroxylin, 0.09-0.1 kg of camphor, 7.5 kg of ethyl acetate, 12 kg of amyl acetate and 1.5 kg of a pigment whose main component is bismuth oxychloride.

The ethyl acetate used in the primer and top coating compositions can be replaced by acetone in the same amount as the ethyl acetate.

### Example 5

For the purpose of time saving, pyroxylin was placed in 20, 50 and 100 liter vessels and dissolved in a solvent to prepare pyroxylin solutions at different concentrations beforehand. Since the pyroxylin solutions could be used whenever necessary, the time required to prepare coating compositions could be reduced.

As in Example 1, it is most preferred to continuously use a primer coating composition, an intermediate coating composition and a top coating composition in this order. As in Example 2, 3 or 4, any one coating process can be omitted or repeated.

The coating method of the present invention can be carried out by common techniques, such as spraying, dipping and brushing.

Imitation pearls can be prepared by repeatedly coating resin beads with the coating composition for surface treatment only.

According to the method of the present invention, pyroxylin may be used in various forms. For example, after pyroxylin is previously dissolved in acetone, ethyl acetate or a mixture thereof and stored, the other components are added to the solution as required.

The contents of the constituent components of the coating compositions are not particularly limited. The contents of the components may be varied depending on temperature and humidity.

The coating method of the present invention is exclusively employed to coat thermoplastic resin beads. Further, the coating method of the present invention can be employed to coat beads other than thermoplastic resin beads. At this time, the coating method of the present invention may be carried out without performing the surface treatment.

As apparent from the above description, according to the coating composition and the coating method of the present invention, pyroxylin is used instead of nitrocellulose, camphor is used as a plasticizer, acetone, butyl acetate or a mixture thereof is used as a solubilizer, and amyl acetate, which is an esterification product of acetic acid and amyl alcohol and is lubricative, is used as another solublizer. By mixing the components in a specified ratio, a satisfactory texture similar to that of natural pearls can be expected, the coating time and drying time can be considerably shortened, and drying can be rapidly performed even at room temperature, thus contributing to an improvement in the productivity of imitation pearls. In addition, the coating surface of the final products is uniform, resulting in better appearance of the final products. Therefore, the coating composition and the coating method of the present invention contribute to an improvement in the commercial value of imitation pearls and a marked reduction in the production costs of imitation pearls. Particularly, the coating composition of the present invention can be coated on thermoplastic resin beads by various coating techniques, such as spraying, dipping and brushing.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A composition for coating resin beads for imitation pearls which comprises pyroxylin, amyl acetate, ethyl acetate, camphor, and a pigment.

2. The composition according to claim 1, wherein the composition is a primer coating composition comprising 1.5 to 6% by weight of pyroxylin, 25 to 60% by weight of ethyl acetate, 30 to 70% by weight of amyl acetate, 0.1 to 0.7% by weight of camphor, and 1 to 8% by weight of a pigment; an intermediate coating composition comprising 1.5 to 6% of pyroxylin, 22 to 45% by weight of ethyl acetate, 30 to 70% by weight of amyl acetate, 0.1 to 0.7% by weight of camphor, and 1 to 8% by weight of a pigment; or a top coating composition comprising 1.5 to 6% by weight of pyroxylin, 10 to 40% by weight of ethyl acetate, 35 to 80% by weight of amyl acetate, 0.1 to 0.7% by weight of camphor, and 1 to 8% by weight of a pigment.

3. The composition according to claim 2, wherein the amount of the amyl acetate used in the intermediate coating composition is at least 3% higher than that used in the primer coating composition, and the amount of the amyl acetate in the top coating composition is at least 3% higher than that used in the intermediate coating composition.

4. The composition according to claim 2, wherein the bismuth oxychloride is partly replaced with titanium dioxide such that the titanium dioxide and the bismuth oxychloride are mixed in a weight ratio of 60-90:10-40.

5. The composition according to claim 1, wherein the pyroxylin is dissolved in acetone, ethyl acetate, a mixture of acetone and ethyl acetate, a mixture of ethyl acetate and butyl acetate, or a mixture of acetone and butyl acetate.

6. The composition according to claim 1, wherein acetone is used instead of the ethyl acetate.

7. A method for coating resin beads for imitation pearls, the method comprising the steps of surface-treating resin beads with a surface-treating agent and coating the surface-treated resin beads twice or more with a coating composition wherein the surface-treating agent comprises 1.5 to 6% by weight of pyroxylin, 20 to 50% by weight of acetone, 20 to 50% by weight of ethyl acetate, 10 to 30% by weight of butyl acetate, 0.1 to 0.7% by weight of camphor, and 2 to 10% by weight of a benzene compound.

8. The method according to claim 7, wherein the surface-treated resin beads sequentially undergo first coating, second coating, and third coating.

9. The method according to claim 7, wherein the surface-treated resin beads are repeatedly coated with one composition selected from a primer coating composition, an intermediate coating composition, and a top coating composition.
